(19) United States
(12) Patent Application Publication
(10) Pub. No.: US 2025/0036760 A1
(43) Pub. Date: Jan. 30, 2025

(54) SECURITY ANALYSIS DEVICE, SECURITY ANALYSIS METHOD, AND COMPUTER READABLE MEDIUM

(71) Applicant: Mitsubishi Electric Corporation, Tokyo (JP)

(72) Inventors: Takeshi ASAI, Tokyo (JP); Ryosuke SHIMABE, Tokyo (JP)

(73) Assignee: Mitsubishi Electric Corporation, Tokyo (JP)

(21) Appl. No.: 18/911,109

(22) Filed: Oct. 9, 2024

Related U.S. Application Data
(63) Continuation of application No. PCT/JP2022/021710, filed on May 27, 2022.

(51) Int. Cl. G06F 21/55

(52) U.S. Cl. CPC G06F 21/554; G06F 2221/034

(57) ABSTRACT

A scenario analysis unit (22) identifies an attack scenario indicating a chronological sequence of attack methods up to occurrence of a threat that may occur in a constituent element of a system. A past case collection unit (231) collects information on attack cases that have occurred in the past. A past case analysis unit (232) identifies a past scenario indicating a chronological sequence of attack methods for each attack case. A likelihood calculation unit (233) calculates a similarity between the attack scenario and the past scenario. Then, the likelihood calculation unit (233) calculates a likelihood of occurrence of the threat based on the similarity.

### CROSS REFERENCE TO RELATED APPLICATION

This application is a Continuation of PCT International Application No. PCT/JP2022/021710, filed on May 27, 2022, which is hereby expressly incorporated by reference into the present application.

### TECHNICAL FIELD

The present disclosure relates to a technology to estimate a magnitude of a risk due to a threat that may occur in a constituent element of a system.

### BACKGROUND ART

Necessary security measures need to be identified and implemented for IT systems, IoT devices, industrial control systems, and the like. IT is an abbreviation for information technology. IoT is an abbreviation for Internet of things. For this purpose, security risk assessment (hereafter referred to as security analysis) needs to be carried out. However, there are not enough guides that indicate specific procedures for analysis. This is a factor that hinders the implementation and establishment of security analysis in each organization.

Non-Patent Literature 1 and Non-Patent Literature 2 describe security analysis.

Non-Patent Literature 1 presents a security analysis implementation guide. This implementation guide provides specifies procedures for security analysis and provides examples and explanations. This implementation guide presents a method for determining a likelihood of occurrence of a threat and so on.

Non-Patent Literature 2 presents a method for driving an index value for calculating a risk value without requiring advanced knowledge of security. In Non-Patent Literature 2, an index value is determined by creating an attack graph, counting the number of vulnerabilities that can be used in attacks and the number of legitimate functions that can be exploited, and making a determination based on a threshold.

### CITATION LIST

### Non-Patent Literature

Non-Patent Literature 1: IPA, “Security Analysis Guide for control Systems, Second Edition”, 2018
Non-Patent Literature 2: Ryo Mizushima, Hirofumi Ueda, Masaki Inokuchi, Tomohiko Yagyu, “Consideration of Calculation of Evaluation Indices for Cyber Attack Risk Assessment”, 2020

### SUMMARY OF INVENTION

### Technical Problem

The method for determining a likelihood of occurrence of a threat described in Non-Patent Literature 1 remains to be dependent on individual skills. Therefore, a problem is that obtained results vary depending on the analyst. The dependence on individual skills in the method for determining a likelihood of occurrence of a threat described in Non-Patent Literature 1 is the dependence on individual skills of the following (1) to (3).

### (1) Dependence on Individual Skills Regarding Indicators

There are a case (a) where indicators are prescribed in an analysis standard, method, or guide and a case (b) where indicators are not prescribed in an analysis standard, method, or guide. In the case (b), only examples or references are indicated. Most cases are the case (b). In the case (b), the indicators are determined based on the subjective judgment of the analyst. Therefore, the determination of the indicators is dependent on individual skills.

### (2) Dependence on Individual Skills Regarding Values to be Set According to Indicators

In both (a) and (b), the criteria for setting indicator values are often qualitative. Therefore, the values are set based on the subjective judgment of the analyst. In other words, whether or not the criteria are satisfied depends on the individual. That is, the values to be set according to the indicators are dependent on individual skills.

### (3) Dependence on Individual Skills Regarding Work (=Technical Difficulty)

When making judgments, the analyst is assumed to have knowledge of the attack method and the attack target. For those with little experience or those with insufficient understanding of the target, it is technically difficult to make judgements, and they are unable to complete work. That is, the work itself is dependent on individual skills.

Non-Patent Literature 2 has been devised to solve the dependence on individual skills of (3). However, in order to implement the method described in Non-Patent Literature 2, many thresholds need to be determined. Results vary with the thresholds. However, appropriate thresholds cannot be categorically known. Therefore, the dependence on individual skills of (3) remains and has not been solved.

An object of the present disclosure is to make it possible to reduce dependence on individual skills when a likelihood of occurrence of a threat is determined.

### Solution to Problem

A security analysis device according to the present disclosure includes
a likelihood calculation unit to calculate a likelihood of occurrence of a threat that may occur in a constituent element of a system, based on a similarity of an attack scenario indicating a chronological sequence of an attack method up to occurrence of the threat and a past scenario indicating a chronological sequence of an attack method in an attack case that has occurred previously.

### Advantageous Effects of Invention

In the present disclosure, a likelihood of occurrence of a threat is calculated based on a similarity between an attack scenario and a past scenario. This allows the likelihood of occurrence of the threat to be determined by calculation by identifying the attack scenario and the past scenario. This reduces technical difficulty in determining a likelihood of occurrence of a threat. As a result, it is possible to reduce dependence on individual skills when a likelihood of occurrence a threat is determined.

### BRIEF DESCRIPTION OF DRAWINGS

FIG. 1 is a hardware configuration diagram of a security analysis device 10 according to Embodiment 1;

FIG. 2 is a functional configuration diagram of the security analysis device 10 according to Embodiment 1;

FIG. 3 is a flowchart of overall processing by the security analysis device 10 according to Embodiment 1;

FIG. 4 is a figure describing a threat DB 31 according to Embodiment 1;

FIG. 5 is a figure describing an attack DB 32 according to Embodiment 1;

FIG. 6 is a figure describing an attack scenario according to Embodiment 1;

FIG. 7 is a flowchart of an occurrence likelihood determination process according to Embodiment 1;

FIG. 8 is a figure describing a past scenario according to Embodiment 1;

FIG. 9 is a figure describing characters that identify attack methods according to Embodiment 1;

FIG. 10 is a figure describing a character string representing an attack scenario according to Embodiment 1;

FIG. 11 is a figure describing a character string representing a past scenario according to Embodiment 1;

FIG. 12 is a configuration diagram of the security analysis device 10 according to Variation 1;

FIG. 13 is a functional configuration diagram of the security analysis device 10 according to Embodiment 2;

FIG. 14 is a flowchart of overall processing by the security analysis device 10 according to Embodiment 2; and

FIG. 15 is a flowchart of the occurrence likelihood identification process according to Embodiment 1.

### DESCRIPTION OF EMBODIMENTS

### Embodiment 1

### ***Description of Configuration***

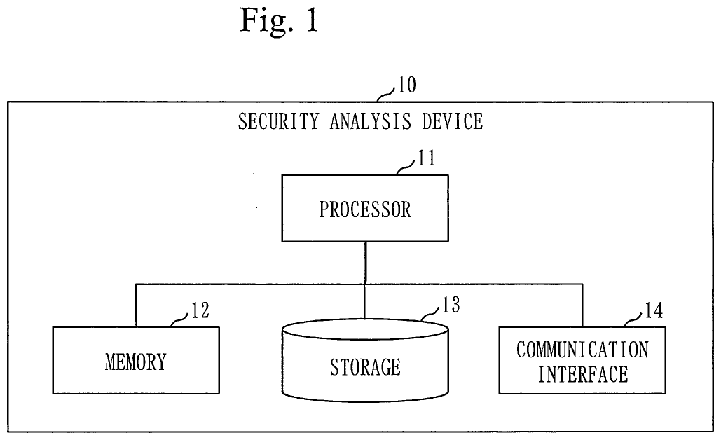

Referring to FIG. 1, a hardware configuration of a security analysis device 10 according to Embodiment 1 will be described.

The security analysis device 10 is a computer.

The security analysis device 10 includes hardware of a processor 11, a memory 12, a storage 13, and a communication interface 14. The processor 11 is connected with other hardware components through signal lines and controls these other hardware components.

The processor 11 is an IC that performs processing. IC is an abbreviation for integrated circuit. Specific examples of the processor 11 are a CPU, a DSP, and a GPU. CPU is an abbreviation for central processing unit. DSP is an abbreviation for digital signal processor. GPU is an abbreviation for graphics processing unit.

The memory 12 is a storage device to temporarily store data. Specific examples of the memory 12 are an SRAM and a DRAM. SRAM is an abbreviation for static random access memory. DRAM is an abbreviation for dynamic random access memory.

The storage 13 is a storage device to store data. A specific example of the storage 13 is an HDD. HDD is an abbreviation for hard disk drive. Alternatively, the storage 13 may be a portable recording medium such as an SD (registered trademark) memory card, CompactFlash (registered trademark), a NAND flash, a flexible disk, an optical disc, a compact disc, a Blu-ray (registered trademark) disc, or a DVD. SD is an abbreviation for Secure Digital. DVD is an abbreviation for digital versatile disk.

The communication interface 14 is an interface for communicating with other devices. Specific examples of the communication interface 14 are an Ethernet (registered trademark) port, a USB port, and an HDMI (registered trademark) port. USB is an abbreviation for Universal Serial Bus. HDMI is an abbreviation for High-Definition Multimedia Interface.

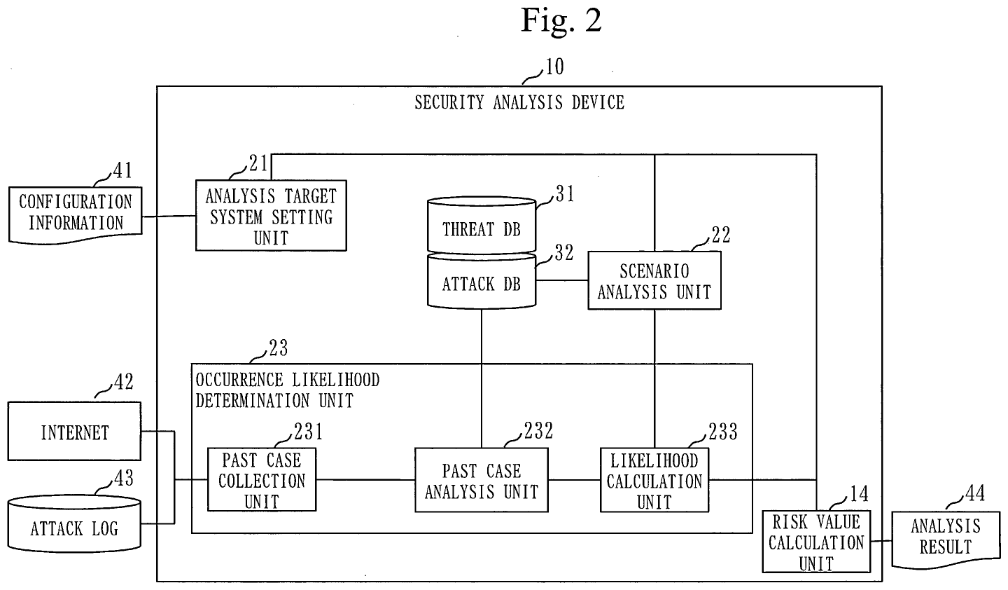

Referring to FIG. 2, a functional configuration of the security analysis device 10 according to Embodiment 1 will be described.

The security analysis device 10 includes, as functional components, an analysis target system setting unit 21, a scenario analysis unit 22, an occurrence likelihood determination unit 23, and a risk value calculation unit 24. The occurrence likelihood determination unit 23 includes a past case collection unit 231, a past case analysis unit 232, and a likelihood calculation unit 233. The functions of the functional components of the security analysis device 10 are realized by software.

The storage 13 stores programs that realize the functions of the functional components of the security analysis device 10. These programs are read into the memory 12 by the processor 11 and executed by the processor 11. This realizes the functions of the functional components of the security analysis device 10.

The storage 13 also realizes functions of a threat DB 31 and an attack DB 32. DB is an abbreviation for database.

The security analysis device 10 takes as input configuration information 41, information obtained from Internet 42, and an attack log 43, and outputs an analysis result 44.

In FIG. 1, only one processor 11 is illustrated. However, there may be a plurality of processors 11, and the plurality of processors 11 may cooperate to execute the programs that realize the functions.

### ***Description of Operation***

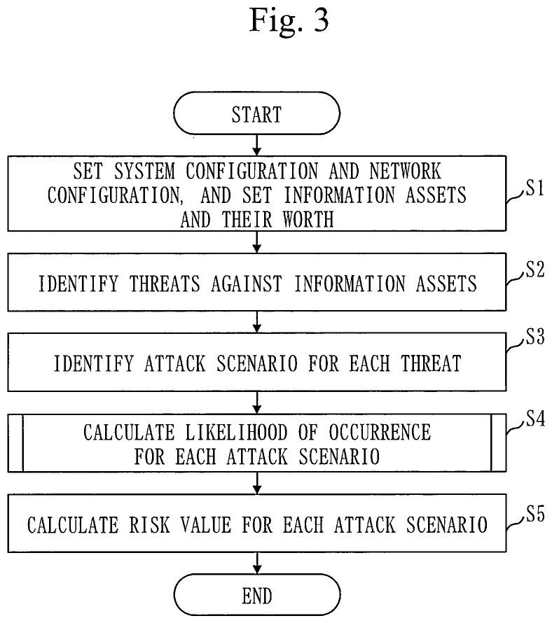

Referring to FIGS. 3 to 11, operation of the security analysis device 10 according to Embodiment 1 will be described.

A procedure for the operation of the security analysis device 10 according to Embodiment 1 is equivalent to a security analysis method according to Embodiment 1. A program that realizes the operation of the security analysis device 10 according to Embodiment 1 is equivalent to a security analysis program according to Embodiment 1

Referring to FIG. 3, overall processing by the security analysis device 10 according to Embodiment 1 will be described.

### (Step S1: Configuration Information Acquisition Process)

The analysis target system setting unit 21 acquires the configuration information 41 of an analysis target system.

The configuration information 41 includes information about each constituent element of devices or like constituting the analysis target system, such as a type and a situation of implemented security measures. The configuration information 41 also includes information about information assets present in each constituent element and worth of the information assets. The configuration information 41 is set by a user in advance.

### (Step S2: Threat Identification Process)

The scenario analysis unit 22 identifies threats that are expected to occur for each constituent element of the analysis target system indicated by the configuration information 41 acquired in step S1.

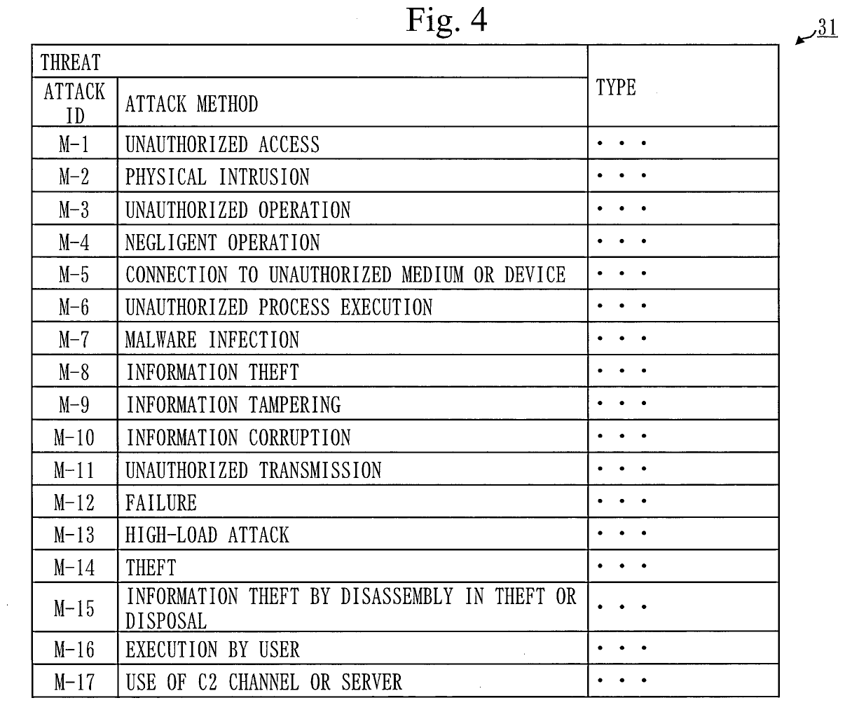

Specifically, the scenario analysis unit 22 sets each constituent element as a target constituent element. The scenario analysis unit 22 refers to the threat DB 31 to identify threats that are expected to occur in the target constituent element. As indicated in FIG. 4, types of constituent elements in which a threat is expected to occur is set for each threat in the threat DB 31. Here, each threat is assigned an attack ID and an attack method. The scenario analysis unit 22 identifies each threat that is expected to occur in the target constituent element by identifying each threat corresponding to the type of the target constituent element. The method for identifying a threat expected to occur in the target constituent element is not limited to this, and methods using other existing techniques may also be used.

The scenario analysis unit 22 may identify each threat by having the user select a threat that is expected to occur in the target constituent element. In this case, the scenario analysis unit 22 may present information from the threat DB 31 to the user.

### (Step S3: Scenario Identification Process)

For each threat for each constituent element identified in step S2, the scenario analysis unit 22 identifies an attack scenario indicating a chronological sequence of attack methods leading to occurrence of the threat.

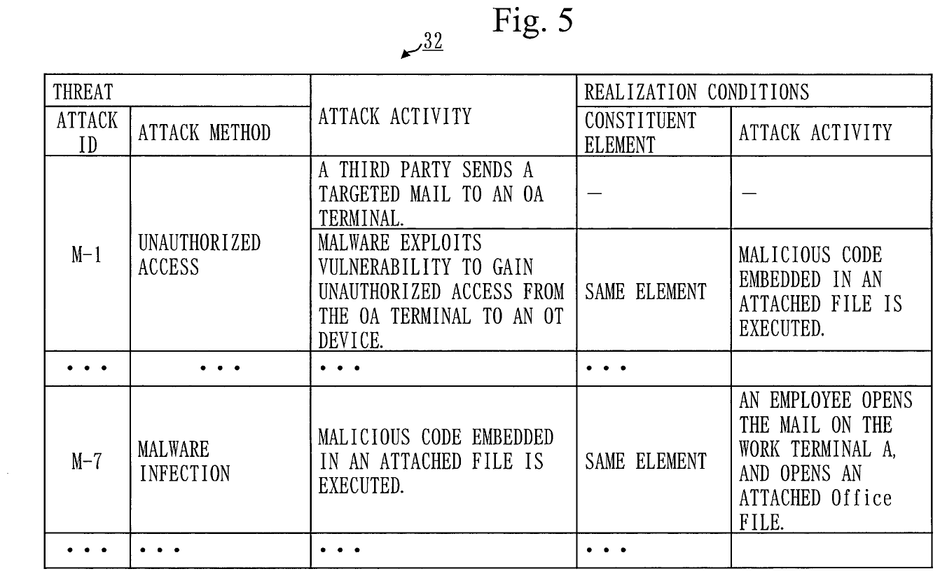

Specifically, the scenario analysis unit 22 sets each threat for each constituent element as a target threat. The scenario analysis unit 22 refers to the attack DB 32 to identify an attack scenario for the target threat. As indicated in FIG. 5, in the attack DB 32, one or more combinations of an attack activity and realization conditions are set for each threat. An attack activity is a specific activity that causes a threat. Realization conditions are prerequisites for realizing an attack activity. Here, information on a constituent element and another attack activity are set as the realization conditions. The scenario analysis unit 22 identifies an attack activity that satisfies the realization conditions for the target threat by pattern matching. If there is another attack activity that is a prerequisite for the identified attack activity, that attack activity is identified. The scenario analysis unit 22 identifies the attack scenario by repeating this process.

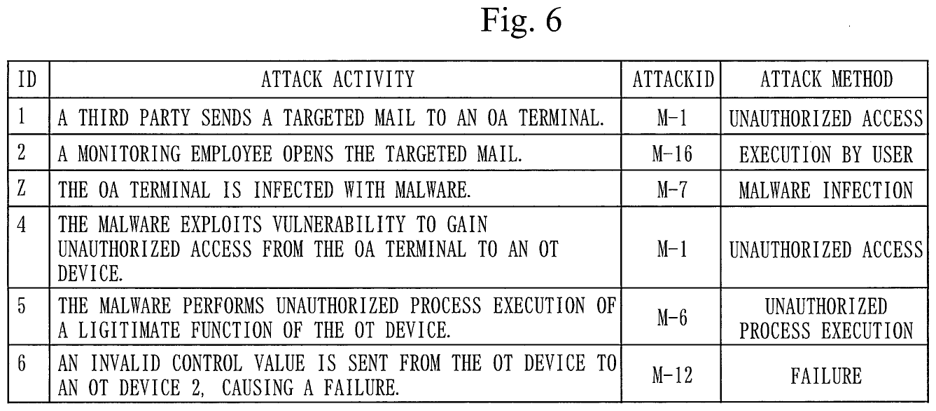

That is, the scenario analysis unit 22 identifies a chronological sequence “an attack activity that causes a threat”→“an attack activity that is a prerequisite for realizing this attack activity”→“an attack activity that is a prerequisite for realizing this attack activity”, and so on. For each attack activity, a corresponding attack method is set. Therefore, for example, an attack scenario indicating a chronological sequence of attack methods as indicated in FIG. 6 is identified.

The scenario analysis unit 22 may have the user identify an attack scenario for the target threat. In this case, the scenario analysis unit 22 may present information from the attack DB 32 to the user.

A method for identifying an attack scenario is described in a document “Xinming Ou, Sudhakar Govindavajhala, Andrew W. Appel, “MulVAL: A Logic-based Network Security Analyzer”, USENIX Security Symposium, 2005”. The scenario analysis unit 22 may identify an attack scenario using the technology described in this document.

### (Step S4: Occurrence Likelihood Determination Process)

The occurrence likelihood determination unit 23 determines a likelihood of occurrence for each threat for each constituent element identified in step S2.

A cyberattack carried out by an attacker group against a target organization is likely to be carried out again similarly, including its execution sequence. Therefore, the likelihood of occurrence of the threat is calculated here based on a similarity in scenario to an attack case that has occurred in the past.

Specifically, the occurrence likelihood determination unit 23 sets each threat for each constituent element as a target threat. The occurrence likelihood determination unit 23 sets the attack scenario identified in step S3 for the target threat as a target attack scenario. The occurrence likelihood determination unit 23 calculates a likelihood of occurrence of the target threat based on a similarity between the target attack scenario and a past scenario indicating a chronological sequence of attack methods in an attack case that has occurred in the past.

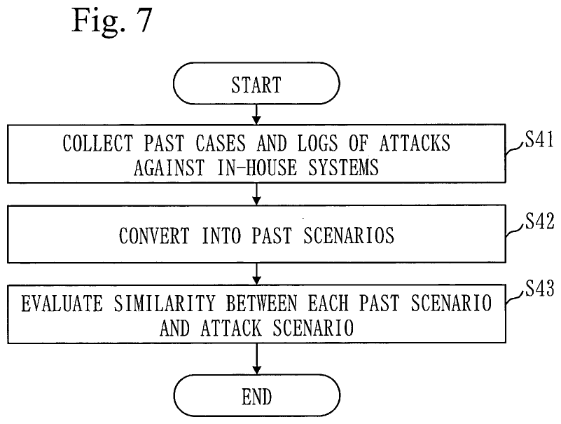

Referring to FIG. 7, this will be described more specifically.

### (Step S41: Past Case Collection Process)

The past case collection unit 231 collects information on attack cases that have occurred in the past.

Specifically, the past case collection unit 231 collects information on external cyberattack cases that have occurred in the past via the Internet 42. For example, the past case collection unit 231 collects information on cyberattack cases that have occurred at external locations from white papers issued by security vendors, academic papers, published blog posts, and so on. For example, IPA has published supplementary materials for a security risk analysis guide for control systems: a series of “cyber incident cases related to control systems”. IPA is an abbreviation for Information-technology Promotion Agency. This series is documents that describe overviews and attack scenarios of incident cases against control systems that have occurred in the past. Collection is possible using web crawling technology or web scraping technology.

The past case collection unit 231 also collects the attack log 43 for in-house systems. The attack log 43 is a log of cyberattacks on the systems operated and managed in-house.

### (Step S42: Past Case Analysis Process)

The past case analysis unit 232 identifies a past scenario indicating a chronological sequence of attack methods for each attack case collected in step S41. It is assumed that past scenarios are in the same format as the attack scenarios identified in step S3.

Specifically, the past case analysis unit 232 sets each collected attack case as a target attack case. The past case analysis unit 232 presents the target attack case and also information from the attack DB 32 to the user. Then, the past case analysis unit 232 has the user specify attack activities in the attack DB 32 respectively for attacks in the target attack case. At this time, the past case analysis unit 232 may assist processing by the user using MITRE, Threat Report ATT&CK Mapper, or the like.

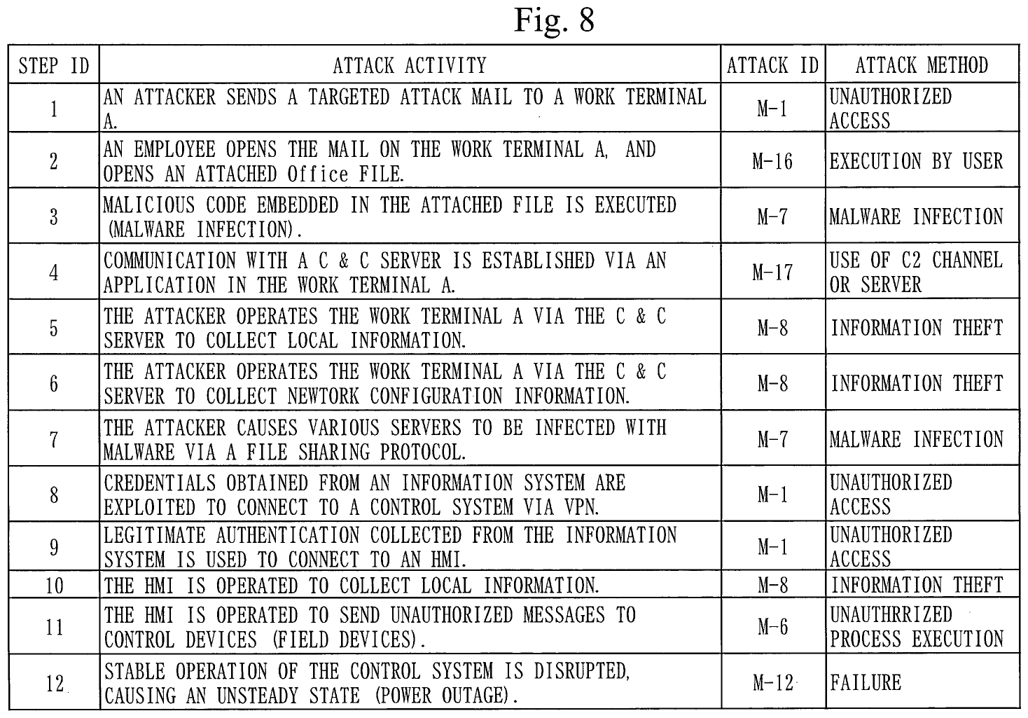

For example, the past scenario indicated in FIG. 8 is identified.

Here, the past case analysis unit 232 presents the information from the attack DB 32 used in step S3 to the user. However, the past case analysis unit 232 may present information from a database different from the attack DB 32 used in step S3. In this case, however, the past case analysis unit 232 needs to present information from a database whose attack methods correspond to those of the attack DB 32 used in step S3.

### (Step S43: Likelihood Calculation Process)

The likelihood calculation unit 233 calculates a similarity between the target attack scenario and each past scenario identified in step S42. Then, the likelihood calculation unit 233 calculates a likelihood of occurrence of the target threat based on the calculated similarity.

The attack scenario and the past scenario indicate chronological sequences of attack methods. That is, the attack scenario and the past scenario are serial data with a temporal order. Therefore, the likelihood calculation unit 233 calculates the similarity between the attack scenario and the past scenario using an evaluation method that evaluates a similarity of serial data. Such evaluation methods include a method using the Levenshtein distance and a method using dynamic time warping. The evaluation methods are not limited to the method using the Levenshtein distance and the method using dynamic time warping, and other methods may be used provided that a method allows comparison of serial data. The target of evaluation is serial data and individual pieces of data constituting the serial data. The serial data is the attack scenario and the past scenario here. The individual pieces of data are attack methods constituting the attack scenario and the past scenario.

A case where the Levenshtein distance is used will be described here as an example.

The likelihood calculation unit 233 represents each of a plurality of attack methods constituting each of the attack scenario and the past scenario with one or more characters that identify each of the attack methods. That is, one attack method is represented by one or more characters. As a result, the attack scenario becomes a character string in which characters respectively identifying the plurality of attack methods are arranged in the chronological sequence up to the occurrence of the threat. The past scenario becomes a character string in which characters respectively identifying the plurality of attack methods are arranged according to the chronological sequence in the attack case.

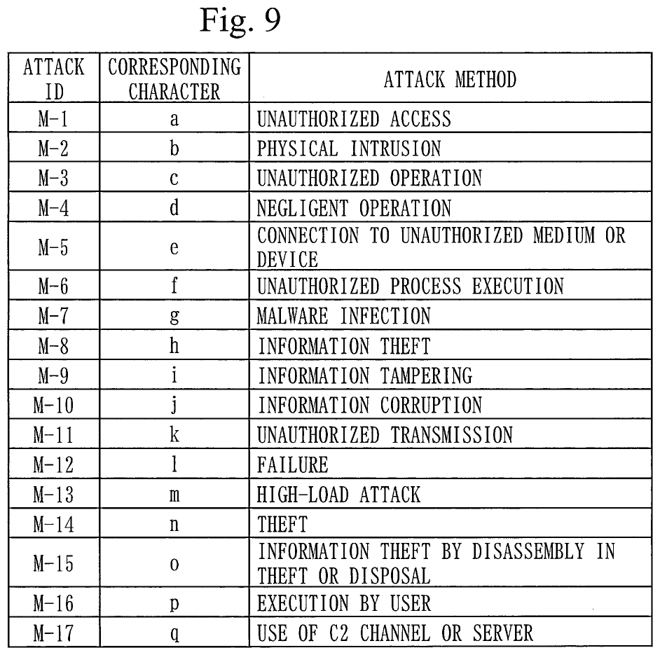

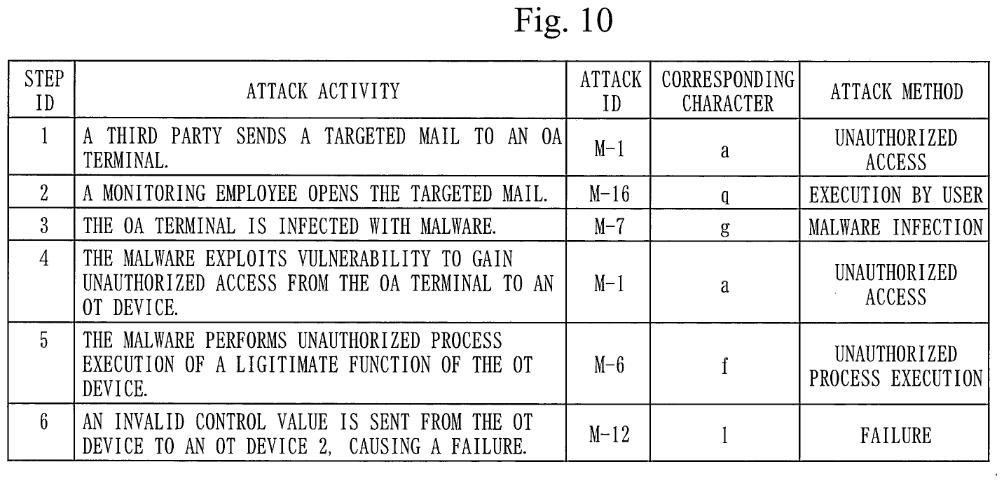

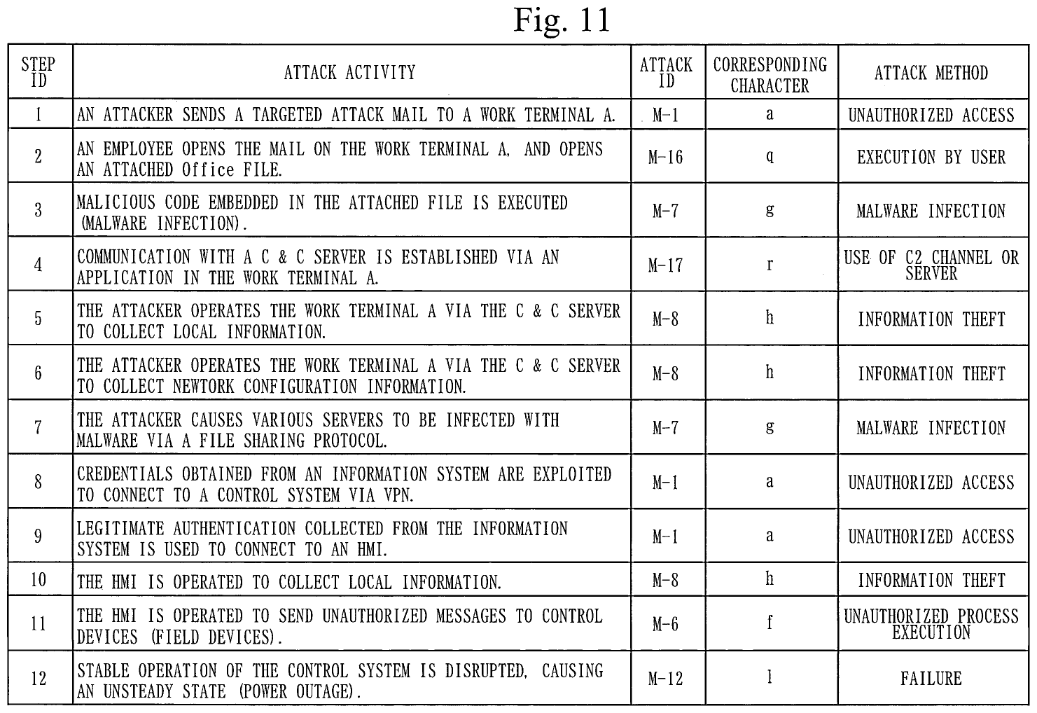

For example, it is assumed that characters that respectively identify a plurality of attack methods are set as indicated in FIG. 9. Then, the attack scenario indicated in FIG. 6 is represented by a character string “aqgafl”, as indicated in FIG. 10. The past scenario indicated in FIG. 8 is represented by a character string “aqgrhhgaahfl”, as indicated in FIG. 11.

The likelihood calculation unit 233 calculates the Levenshtein distance between the character string “aqgafl” representing the attack scenario and the character string “aqgrhhgaahfl” representing the past scenario. In this case, the Levenshtein distance is 6. To be precise, the Levenshtein distance expresses a non-similarity. Therefore, the smaller the value is, the more similar the two character strings are. The larger the value is, the more dissimilar the two character strings are. Therefore, the likelihood calculation unit 233 calculates a reciprocal of the Levenshtein distance as a similarity. That is, the similarity is 0.16 (≈⅙) here.

Then, the likelihood calculation unit 233 calculates the likelihood of occurrence of the target threat based on the similarity. For example, if there is one past scenario, the likelihood calculation unit 233 treats the similarity as the likelihood of occurrence. If there are a plurality of past scenarios, the likelihood calculation unit 233 treats an average value or the like of the similarities as the likelihood of occurrence.

### (Step S5: Risk Value Calculation Process)

The risk value calculation unit 24 calculates a risk value for each constituent element of the analysis target system.

Specifically, the risk value calculation unit 24 sets each constituent element of the analysis target system as a target constituent element. The risk value calculation unit 24 calculates a risk value in the target constituent element based on the occurrence likelihood calculated in step S4 for the threat expected to occur in the target constituent element and the worth of information assets existing in the target constituent element. The risk value calculation unit 24 calculates, as the risk value, a product of the likelihood of occurrence and the worth of the information assets here.

If there are a plurality of threats expected to occur in the target constituent element, the risk value calculation unit 24 calculates a product of the likelihood of occurrence and the worth of the information assets for each threat. Then, the risk value calculation unit 24 calculates the sum or like of the calculated values as the risk value in the target constituent element.

Then, for each constituent element of the analysis target system, the risk value calculation unit 24 generates the analysis result 44 indicating the information assets, each threat, the likelihood of occurrence of each threat, and the risk value.

### Effects of Embodiment 1

As described above, the security analysis device 10 according to Embodiment 1 calculates a likelihood of occurrence of a threat based on a similarity between an attack scenario and a past scenario. This allows the likelihood of occurrence of the threat to be determined by calculation by identifying the attack scenario and the past scenario. This reduces the technical difficulty in determining a likelihood of occurrence of a threat. As a result, it is possible to reduce dependence on individual skills when a likelihood of an occurrence of a threat is determined.

### ***Other Configurations***

### Variation 1

In Embodiment 1, the functional components are realized by software. However, as Variation 1, the functional components may be realized by hardware. With regard to this Variation 1, differences from Embodiment 1 will be described.

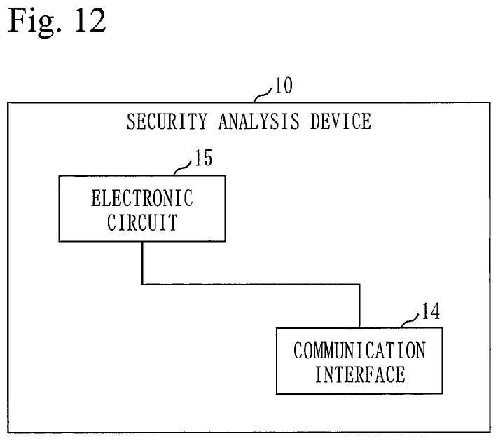

Referring to FIG. 12, a configuration of the security analysis device 10 according to Variation 1 will be described.

When the functional components are realized by hardware, the security analysis device 10 includes an electronic circuit 15 in place of the processor 11, the memory 12, and the storage 13. The electronic circuit 15 is a dedicated circuit that realizes the functions of the functional components, the memory 12, and the storage 13.

The electronic circuit 15 is assumed to be a single circuit, a composite circuit, a programmed processor, a parallel-programmed processor, a logic IC, a GA, an ASIC, or an FPGA. GA is an abbreviation for gate array. ASIC is an abbreviation for application specific integrated circuit. FPGA is an abbreviation for field-programmable gate array.

The functional components may be realized by one electronic circuit 15, or the functional components may be distributed to and realized by a plurality of electronic circuits 15.

### Variation 2

As Variation 2, some of the functional components may be realized by hardware, and the rest of the functional components may be realized by software.

Each of the processor 11, the memory 12, the storage 13, and the electronic circuit 15 is referred to as processing circuitry. That is, the functions of the functional components are realized by the processing circuitry.

### Embodiment 2

Embodiment 2 differs from Embodiment 1 in that an amplified scenario is generated from a past scenario and a likelihood of occurrence of a threat is determined using the amplified scenario. In Embodiment 2, this difference will be described, and description of the same aspects will be omitted.

### ***Description of Configuration***

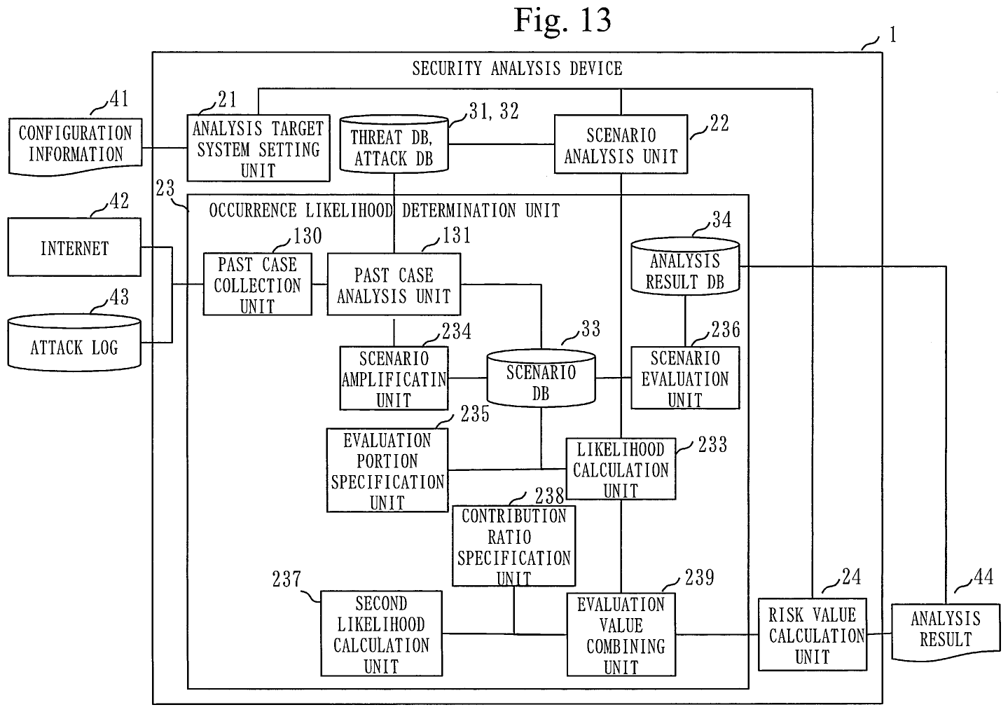

Referring to FIG. 13, a functional configuration of the security analysis device 10 according to Embodiment 2 will be described.

The security analysis device 10 differs from the security analysis device 10 illustrated in FIG. 2 in that the occurrence likelihood determination unit 23 includes a scenario amplification unit 234, an evaluation portion specification unit 235, a scenario evaluation unit 236, a second likelihood calculation unit 237, a contribution ratio specification unit 238, and an evaluation value combining unit 239. Another difference from the security analysis device 10 illustrated in FIG. 2 is that the storage 13 realizes a scenario DB 33 and an analysis result DB 34.

### ***Description of Operation***

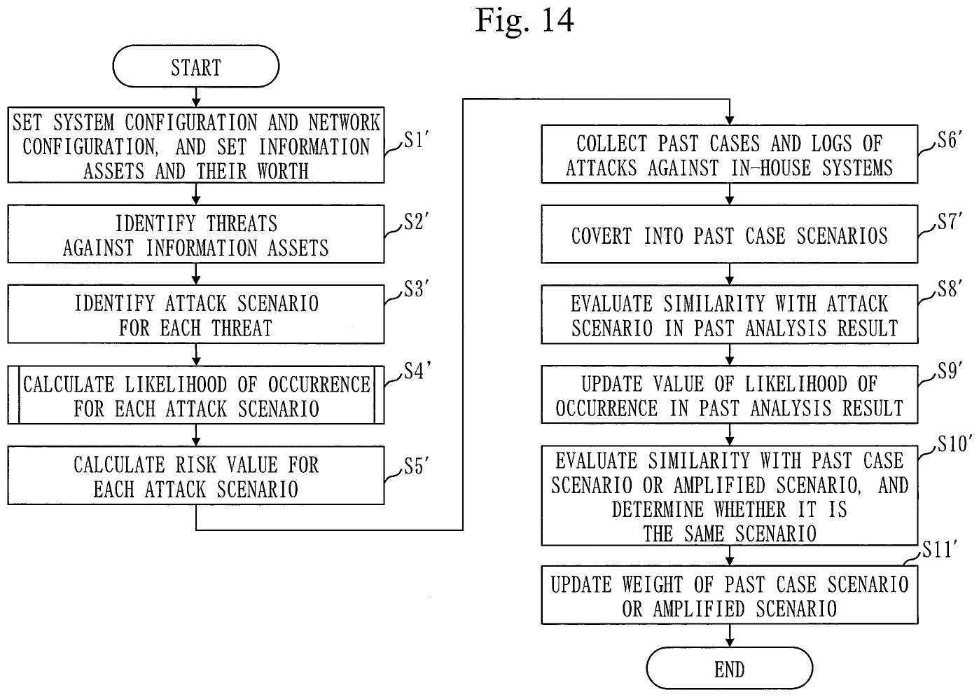

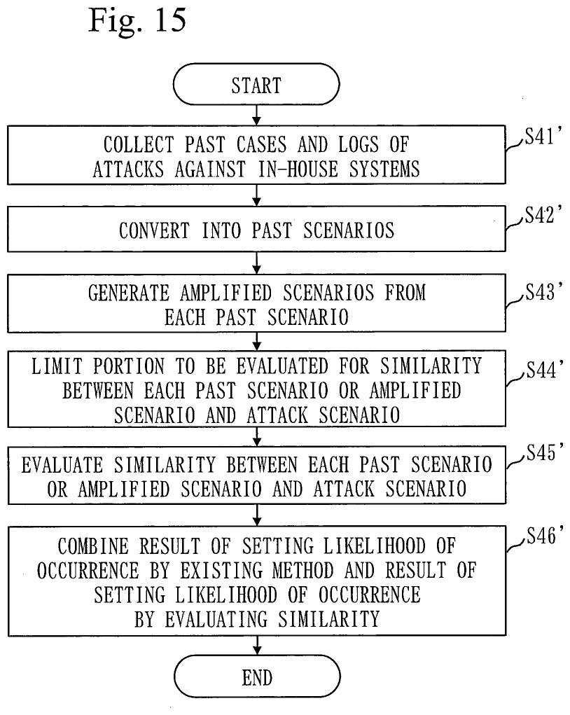

Referring to FIGS. 14 and 15, operation of the security analysis device 10 according to Embodiment 2 will be described.

A procedure for the operation of the security analysis device 10 according to Embodiment 2 is equivalent to the security analysis method according to Embodiment 2. A program that realizes the operation of the security analysis device 10 according to Embodiment 2 is equivalent to the security analysis program according to Embodiment 2.

Referring to FIG. 14, overall processing by the security analysis device 10 according to Embodiment 2 will be described.

The processes of step S1′ to step S3′ are the same as the processes of step S1 to step S3 in FIG. 3. The process of step S5′ is the same as the process of step S5 in FIG. 3.

### (Step S4′: Occurrence Likelihood Determination Process)

The occurrence likelihood determination unit 23 determines a likelihood of occurrence for each threat for each constituent element identified in step S2. At this time, the occurrence likelihood determination unit 23 generates an amplified scenario from a past scenario, and determines the likelihood of occurrence of the threat using the amplified scenario.

Referring to FIG. 15, this will be described specifically.

The processes of step S41′ to step S42′ are the same as the processes of step S41 to step S42 in FIG. 7. Note that information on attack cases that have been already collected is not collected in step S41′. This is because past scenarios generated from the attack cases that have already been collected are accumulated in the scenario DB 33, as will be described later.

### (Step S43′: Scenario Amplification Process)

The scenario amplification unit 234 amplifies each past scenario generated in step S42′ to generate an amplified scenario.

Specifically, the scenario amplification unit 234 sets each past scenario as a target past scenario. The scenario amplification unit 234 generates an amplified scenario by changing the chronological sequence of a plurality of attack methods constituting the target past scenario. The scenario amplification unit 234 also generates an amplified scenario by deleting one or more attack methods of the plurality of attack methods constituting the target past scenario. The scenario amplification unit 234 generates amplified scenarios exhaustively here. That is, the scenario amplification unit 234 generates amplified scenarios of all patterns obtained by changing the chronological sequence of the plurality of attack methods. The scenario amplification unit 234 also generates amplified scenarios of all patterns obtained by deleting one or more attack methods of the plurality of attack methods.

The generated amplified scenarios include those that are not feasible. Specifically, those that are not feasible because the order of attack methods is not feasible are included. Those that are not feasible because an attack method is deleted are included. For example, the order in which a malware infection occurs and then an unauthorized access by the infecting malware is reasonable, but the reverse order is not feasible. Therefore, the scenario amplification unit 234 deletes amplified scenarios that are not feasible. At this time, the scenario amplification unit 234 refers to the realization conditions in the attack DB 32, and eliminates scenarios that do not satisfy the conditions. For example, an amplified scenario in which another attack activity Y that is a prerequisite for an attack activity X is not carried out before the attack activity X is eliminated.

The scenario amplification unit 234 writes the past scenarios and the amplified scenarios to the scenario DB 33.

### (Step S44′: Evaluation Portion Specification Process)

The evaluation portion specification unit 235 specifies a portion to be evaluated when a similarity between an attack scenario and a past scenario or an amplified scenario is calculated.

Specifically, the evaluation portion specification unit 235 presents the attack scenario, the past scenario, and the amplified scenario to the user. Then, the evaluation portion specification unit 235 accepts specification of the portion to be evaluated from the user.

Specification is made when the portion to be evaluated or the portion not to be evaluated in the scenarios has been identified. If specification is made, the portion other than the specified portion is deleted from each scenario. Specification is not made when the portion to be evaluated or the portion not to be evaluated in the scenarios has not been identified. If specification is not made, the entirety of each scenarios is to be evaluated.

### (Step S45′: Likelihood Calculation Process)

The likelihood calculation unit 233 calculates a similarity between the target attack scenario and each past scenario identified in step S42′ and a similarity between the target attack scenario and each amplified scenario generated in step S43′. At this time, if specification has been made in step S44′, the likelihood calculation unit 233 calculates the similarity using the scenarios from which the portion other than the specified portion has been deleted. As a result, the likelihood calculation unit 233 calculates a similarity between the portion to be evaluated that is part of the attack scenario and the portion to be evaluated that is part of the past scenario or the amplified scenario as a similarity between the attack scenario and the past scenario or the amplified scenario. The similarity is calculated by the same method as that in step S43 in FIG. 7.

Then, the likelihood calculation unit 233 calculates a likelihood of occurrence of the target threat based on the calculated similarity. At this time, the likelihood calculation unit 233 calculates the likelihood of occurrence by giving a heavier weight to the similarity with the past scenario or amplified scenario highly evaluated by the scenario evaluation unit 236 in step S11′.

### (Step S46′: Evaluation Value Combining Process)

The evaluation value combining unit 239 combines a likelihood of occurrence calculated by a different method and the likelihood of occurrence calculated based on the similarity in step S45′ so as to calculate a new likelihood of occurrence. A different method is an existing method for determining a likelihood of occurrence such as one described in Non-Patent Literature 1.

If a likelihood of occurrence is set based on a similarity before a sufficient number of past cases have been collected, an unreasonably low value may be output. In order to avoid such a situation, the evaluation value combining unit 239 updates the likelihood of occurrence by taking into consideration a likelihood of occurrence calculated by a different method.

In this case, the second likelihood calculation unit 237 calculates a likelihood of occurrence by a different method. There may be a case where a likelihood of occurrence calculated by a different method is discrete values such as 1, 2, and 3. In this case, the second likelihood calculation unit 237 normalizes the values using the maximum value of likelihoods of occurrence calculated in step S45′. If the maximum value of likelihoods of occurrence calculated in step S45′ is 1 and discrete values 1, 2, and 3 are obtained, the second likelihood calculation unit 237 normalizes the values to 0.33, 0.66, and 0.99, for example.

The evaluation value combining unit 239 combines the likelihood of occurrence calculated by the different method and the likelihood of occurrence calculated based on the similarity, depending on the collection status of past cases. It is assumed, for example, that the collection status of past cases is one of a start-up period, a transition period, and a steady period. In the start-up period, the evaluation value combining unit 239 compares the likelihood of occurrence calculated by the different method with the likelihood of occurrence calculated based on the similarity, and adopts the likelihood of occurrence whose value is larger. In the transition period, the evaluation value combining unit 239 adopts a weighted average value of the likelihood of occurrence calculated by the different method and the likelihood of occurrence calculated based on the similarity. At this time, the contribution ratio specification unit 238 specifies weights individually for the likelihood of occurrence calculated by the different method and the likelihood of occurrence calculated based on the similarity. The contribution ratio specification unit 238 may have the user input the weights, or may calculate the weights based on output from the scenario evaluation unit 236 to be described later. In the steady period, the evaluation value combining unit 239 adopts the likelihood of occurrence calculated based on the similarity. Note that a plurality of likelihoods of occurrence derived from a plurality of cases are obtained. Therefore, the contribution ratio specification unit 238 may specify weights for the plurality of likelihoods of occurrence corresponding to the plurality of cases, and the evaluation value combining unit 239 may calculate a weighted average value.

### (Step S6′: Attack Log Collection Process)

The past case collection unit 231 collects logs of cyberattacks against the analysis target system.

### (Step S7′: Log Analysis Process)

The past case analysis unit 232 generates a log scenario based on the logs collected in step S6′. The log scenario is generated by the same method by which past scenarios are generated in the process of step S42 in FIG. 7.

### (Step S8′: Similarity Calculation Process)

The scenario evaluation unit 236 sets each threat for each constituent element as a target threat. The scenario evaluation unit 236 sets, as a target attack scenario, the attack scenario identified in step S3 for the target threat. The scenario evaluation unit 236 calculates a similarity between the target attack scenario and the log scenario generated in step S7′. The similarity is calculated by the same method as that in step S43 of FIG. 7.

### (Step S9′: Occurrence Likelihood Updating Process)

The scenario evaluation unit 236 sets each threat for each constituent element as a target threat. The scenario evaluation unit 236 re-calculates the likelihood of occurrence of the target threat using the similarity calculated in step S8′. The scenario evaluation unit 236 rewrites the likelihood of occurrence in the analysis result 44 generated previously to the re-calculated value. Note here that the analysis result 44 generated previously is stored in the analysis result DB 34.

Re-calculation may be performed by any method. A method for re-calculation may be specified by the user. For example, the scenario evaluation unit 236 may set a reciprocal of the similarity calculated in step S8′ as the re-calculated likelihood of occurrence. Alternatively, the scenario evaluation unit 236 may set a weighted average value of the likelihood of occurrence calculated previously and the reciprocal of the similarity calculated in step S8′ as the re-calculated likelihood of occurrence.

### (Step S10′: Second Similarity Calculation Process)

The scenario evaluation unit 236 sets each of each past scenario and each amplified scenario stored in the scenario DB 33 as a target comparison scenario. The scenario evaluation unit 236 calculates a similarity between the target comparison scenario and the log scenario generated in step S7′. The similarity is calculated by the same method as that in step S43 in FIG. 7.

### (Step S11′: Scenario Evaluation Process)

The scenario evaluation unit 236 gives a high evaluation score to a comparison scenario whose similarity calculated in step S10′ is higher than a first threshold. If the similarity calculated in step S10′ is lower than a second threshold with respect to all comparison scenarios, the scenario evaluation unit 236 adds this log scenario to the scenario DB 33 as a new past scenario.

### Effects of Embodiment 2

As described above, the security analysis device 10 according to Embodiment 2 generates an amplified scenario from a past scenario, and determines a likelihood of occurrence of a threat using the amplified scenario. This makes it possible to calculate a likelihood of occurrence of a threat more appropriately.

The security analysis device 10 according to Embodiment 2 updates a likelihood of occurrence based on a log scenario generated from a log of cyberattacks against the analysis target system. This makes it possible to calculate a likelihood of occurrence of a threat more appropriately.

“Unit” in the above description may be interpreted as “circuit”, “step”, “procedure”, “process”, or “processing circuitry”.

The embodiments and variations of the present disclosure have been described above. Two or more of these embodiment and variations may be implemented in combination. Alternatively, one of them or two or more of them may be partially implemented. The present disclosure is not limited to the above embodiments and variations, and various modifications can be made as necessary.

### REFERENCE SIGNS LIST

10: security analysis device, 11: processor, 12: memory, 13: storage, 14: communication interface, 15: electronic circuit, 21: analysis target system setting unit, 211: configuration setting unit, 212: worth setting unit, 22: scenario analysis unit, 23: occurrence likelihood determination unit, 231: past case collection unit, 232: past case analysis unit, 233: likelihood calculation unit, 234: scenario amplification unit, 235: evaluation portion specification unit, 236: scenario evaluation unit, 237: second likelihood calculation unit, 238: contribution ratio specification unit, 239: evaluation value combining unit, 24: risk value calculation unit, 31: threat DB, 32: attack DB, 33: scenario DB, 34: analysis result DB, 41: configuration information, 42: Internet, 43: attack log, 44: analysis result.

1. A security analysis device comprising
processing circuitry to calculate a likelihood of occurrence of a threat that may occur in a constituent element of a system, based on a similarity of an attack scenario indicating a chronological sequence of an attack method up to occurrence of the threat and a past scenario indicating a chronological sequence of an attack method in an attack case that has occurred previously.

2. The security analysis device according to claim 1,
wherein the attack scenario is a character string in which characters respectively identifying a plurality of attack methods are arranged according to a chronological sequence up to occurrence of the threat,
wherein the past scenario is a character string in which the characters are arranged according to a chronological sequence in the attack case, and
wherein the processing circuitry calculates a similarity between the character string of the attack scenario and the character string of the past scenario as a similarity between the attack scenario and the past scenario.

3. The security analysis device according to claim 2,
wherein the processing circuitry uses a Levenshtein distance to calculate a similarity between the character string of the attack scenario and the character string of the past scenario.

4. The security analysis device according to claim 1,
wherein the processing circuitry generates an amplified scenario by changing a chronological sequence of a plurality of attack methods constituting the past scenario or deleting one or more attack methods of the plurality of attack methods constituting the past scenario, and
wherein the processing circuitry calculates the likelihood of occurrence taking into consideration a similarity between the attack scenario and the amplified scenario.

5. The security analysis device according to claim 1,
wherein the processing circuitry calculates a similarity between an evaluation target portion that is part of the attack scenario and an evaluation target portion that is part of the past scenario as a similarity between the attack scenario and the past scenario.

6. The security analysis device according to claim 1,
wherein the processing circuitry combines a likelihood of occurrence calculated by a different method and the likelihood of occurrence calculated by the processing circuitry so as to calculate a new likelihood of occurrence.

7. The security analysis device according to claim 1,
wherein the processing circuitry re-calculates a likelihood of occurrence of the threat based on a similarity between the attack scenario and a log scenario indicating a chronological sequence of an attack method carried out against the system.

8. The security analysis device according to claim 1,
wherein the processing circuitry calculates a risk value in the constituent element based on the likelihood of occurrence calculated by the processing circuitry and worth of an information asset existing in the constituent element.

9. A security analysis method comprising
calculating a likelihood of occurrence of a threat that may occur in a constituent element of a system, based on a similarity of an attack scenario indicating a chronological sequence of an attack method up to occurrence of the threat and a past scenario indicating a chronological sequence of an attack method in an attack case that has occurred previously.

10. A non-transitory computer readable medium storing a security analysis program that causes a computer to function as a security analysis device to perform
a likelihood calculation process of calculating a likelihood of occurrence of a threat that may occur in a constituent element of a system, based on a similarity of an attack scenario indicating a chronological sequence of an attack method up to occurrence of the threat and a past scenario indicating a chronological sequence of an attack method in an attack case that has occurred previously.
